(19) United States
(12) Patent Application Publication
(10) Pub. No.: US 2013/0262160 A1
(43) Pub. Date: Oct. 3, 2013

(54) Method for the automated communication of parking spaces

(71) Applicant: SCHEIDT & BACHMANN GMBH, Monchengladbach (DE)

(72) Inventors: Norbert Miller, Monchengladbach (DE); Martin Kammler, Monchengladbach (DE)

(73) Assignee: Scheidt & Bachmann GmbH, Monchengladbach (DE)

(21) Appl. No.: 13/726,039

(22) Filed: Dec. 22, 2012

(30) Foreign Application Priority Data
Mar. 27, 2012 (EP) 12 161 550.4

(51) Int. Cl. G06Q 10/02

(52) U.S. Cl. CPC G06Q 10/02
USPC 705/5

(57) ABSTRACT

In a method for automatically communicating parking spaces, parking spaces of different car park operators, at different locations provided for utilisation are recorded by a central computer in a data base indicating at least the location, availability and usage terms and provided for the purpose of automatic management and for being queried via a computer-based network. Suitable parking spaces are offered to a customer starting a query for selection including usage terms, wherein during the query destination is indicated. An automatically generated authorisation identification code is electronically communicated to the customer when booking a parking space.

### BACKGROUND OF THE INVENTION

The present invention relates to a method for the automated communication of parking spaces.

The existing structure consists of public car parks along the roads as well as of commercial parking spaces in the form of over air car parks, multi-storey car parks etc.

Car drivers wanting to go to a retailer, a service provider, a clinic, public authority or the like usually look for a suitable parking space at the respective location. In particular, at the time of looking for a space, they usually have no knowledge of what they will have to pay, possible discount terms or different choices. Therefore they often waste a lot of time without finding the most cost-effective or most convenient available parking space.

Open air parks, multi-storey car parks or comparable parking areas are, as a rule, used by passing trade or people with local knowledge and are not really able to offer utilisation-dependent price structures so that there is no real competition, and customers use car parks randomly, according to location and cost, which means that prior knowledge is the main criterion in the last-mentioned cases.

Frequently establishments open to the public such as retailers, service providers, practices, authorities and the like are not able to offer parking spaces to their visitors which means that so far the possibilities of linking the establishment with a car perk management outfit for use of the car park by customers have been limited. A discounting method is known which is based on parking tickets: if discount terms are met the customer presents the parking ticket to the establishment and the establishment gives a discount on parking by placing a discount marker on the parking ticket. The way this is done is frequently by punching a hole into the ticket at a defined point using a mechanical discounting device. The hole is recognised by the automatic pay station of a multi-story or other car park as entitlement to a discount.

The discounting device would comprise a mechanical counter so that the number of discounts granted (based on the counters of the discounting devices) and the number of discounts used (based on the invoices of the multi-storey or other car park) can be balanced and billing can be performed between the establishment granting the discount and the car park operator. This largely manual procedure has considerable disadvantages under various aspects:
the punched discount marker is, of course, visible, on the parking ticket tempting the customer to commit fraud by punching the discount marker himself without having fulfilled the discount terms.
the car park operator can conclude discounting contracts with only very few establishments, and the reason for this is that only a limited number of technically distinct discount markers can be placed on the parking ticket.
manual balancing between granted and used discounts and billing is difficult; for the same billing period. differences in the counter readings of possibly several mechanical discounting devices (at the establishment) must be balanced against the discounts used (in the multi-storey car park or car park operator) in the same time period. Balancing differences occur frequently and must, depending upon the amount involved, be either tolerated or researched. at considerable expense.

Further systems with an economic link-up possibility between usage by the as and car park management are not known and the described system is comparatively cumbersome and expensive.

Based on the described prior art it is the requirement of the invention to provide a method which overcomes the above-mentioned problems and offers a market place for customers, car park operators and establishments open to the public such as retailers, service providers, practices, authorities etc.

### SUMMARY OF THE INVENTION

A technical solution to this requirement is proposed according to a method comprising the steps of:
a) parking spaces of different car park operators, at different locations provided for utilisation are recorded by a central computer in a data base indicating at least the location, availability and usage terms and provided for the purpose of automatic management and for being queried via a computer-based network,
b) suitable parking spaces are offered to a customer starting a query for selection including usage terms, wherein during the query destination is indicated and
c) an automatically generated authorisation identification code is electronically communicated to the customer when booking parking space.

Further features are defined as follows.

During the query, destination and planned usage period are indicated and parking spaces are determined by the central computer and communicated indicating location, availability and usage terms.

A physical identification medium is generated in accordance with the authorisation identification code.

Discount terms of an establishment linked to the cal park operator are recorded and managed as part of the usage terms.

A booking selection with different parameters such as distance and/or cost is communicated to the customer.

A mobile communications network. is used as the computer-based network.

A mobile terminal looking up and booking parking spaces is used by the customer.

The invention discloses an automatic procedure which offers the computer-based possibility for customers to look for, select and book parking space with a car bark operator via a network-capable device. This means that the customer can plan his visit. It is also possible for multi-storey/car park operators to plan their contingencies. Furthermore new commercial possibilities are opened up by methods according to the invention in that, for example, establishments such as retailers, service providers, practices etc. can pre-book parking space contingencies and offer these directly to their customers. In addition it offers possibilities to the establishments open to the public to discount parking for the customer. The establishment open to the public would link the discounts to conditions such as minimum turnover, turnover frequency, time spent at the establishment and etc. Subsequent settlement of the discounts used between the establishment and the car park operator is effected via a computer-based automated balancing process and statements can be detailed down to individual discounting operations.

According to an advantageous proposal of the invention the method can be operated using a mobile network thereby allowing customers to look for, and book their parking space via a mobile terminal, for example a smart phone etc.

Advantageously the customer can select parking spaces ad lib using criteria of by the invention. These may be criteria such as cost, discounting scheme and distance/connection to the establishment to be visited. For example, the customer may look for a parking space in the vicinity of his location and the system according to the invention will name available car parks including usage terms; for example “Kings Road multi-storey car park offers 10% discount when you shop at C&A”.

Advantageously, after selecting a parking space, the customer electronically receives an authorisation identification code (called “ID” for short in the following), whereby it is up to the customer whether he receives the ID via a stationary device and prints it out or whether he stores the electronic message containing the ID in a mobile terminal. The ID is also communicated to the selected multi-storey or other car park; it enables the customer to gain access and it identifies him as potentially entitled to a discount at the establishment. Advantageously the ID is designed to be machine-readable and may, for example, be a one- or two-dimensional barcode.

The ID may, for example, be a so-called QR code which the customer merely presents at a corresponding reader thereby allowing him to gain entry to the multi-story or other car park. If required by the multi-story or other car park infrastructure the customer may use the ID to print a physical ticket.

The method offers, as already mentioned, the possibility for customers to register and thus to be identifiable. in particular also account data may be used in order to process corresponding paying operations in an automated manner.

Discount terms offered by the establishments open to the public are advantageously managed in a data base of the system according to the invention. The terms for using a parking space would then be represented by the total of all parking charges including available discounts and associated discount terms. Exactly one set of self-contained usage terms would then apply to each parking space at any time which set would he automatically managed using the invention and be made available to the customer for him to query.

The invention provides for an automated method or a system which, by utilising conventional network technology, data base technology and corresponding computer systems including terminals, offers the possibility of offering, selecting, booking parking spaces and conducting the entire payment process whereby discounting schemes are taken into consideration.

### BRIEF DESCRIPTION OF THE DRAWINGS

Further advantages and features of the invention are given in the description below with reference to the figures, in which

FIG. 1 shows a flow-diagram-type representation of an embodiment for a system according to the invention;

FIG. 2 shows a flow-diagram-type representation explaining an embodiment for setting up a data base;

FIG. 3 shows flow-diagram-type representation of the system of FIG. 1 when a query is conducted;

FIG. 4 shows a flow-diagram-type representation of the system of FIG. 1 when a selection is made;

FIG. 5 shows a flow-diagram-type representation of the procedures at the start of parking space utilisation;

FIG. 6 shows a flow-diagram-type representation in conjunction with the payment operation;

FIG. 7 shows a flow-diagram-type representation when leaving the parking space; and

FIG. 8 shows a flow-diagram-type representation in conjunction with billing.

In the figures identical elements are marked with identical reference symbols.

### DESCRIPTION OF PREFERRED EMBODIMENTS

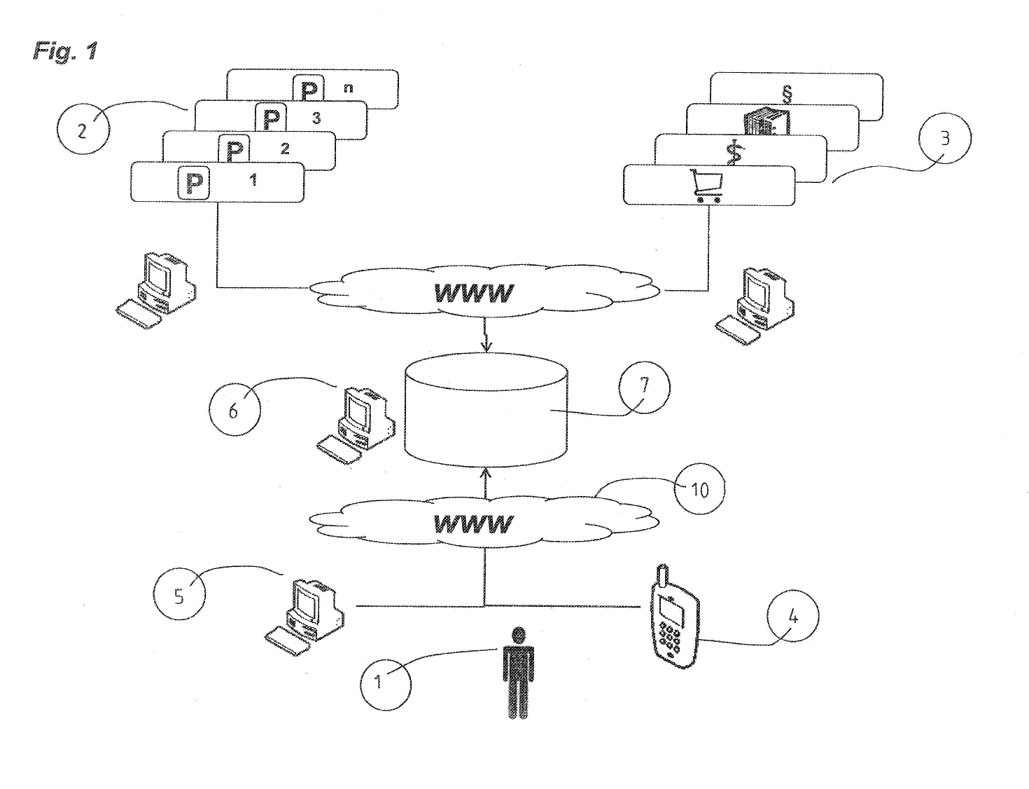

FIG. 1 shows an embodiment for a system according to the invention which supports a commercial relationship between car park operators 2, establishments open to the public 3 and customers 1 based on a central computer 6 with data base 7.

A system based on a central computer 6 operates a data base 7. In the embodiment shown car park operators 2 offering parking spaces of various kinds can connect via the internet to a central computer 6 and enter their parking spaces.

Furthermore establishments open to the public 3, i.e. authorities, shops etc can also, via the internet, enter the in with the central computer, Using mobile terminals 4 or stationary terminals 5 a customer 1 can then make contact via the internet 10 with the central computer 6. He can indicate a location, an establishment open to the public or the like and can arrange for parking spaces with a variety of usage terms to be offered to him. Thereupon he can make his choice.

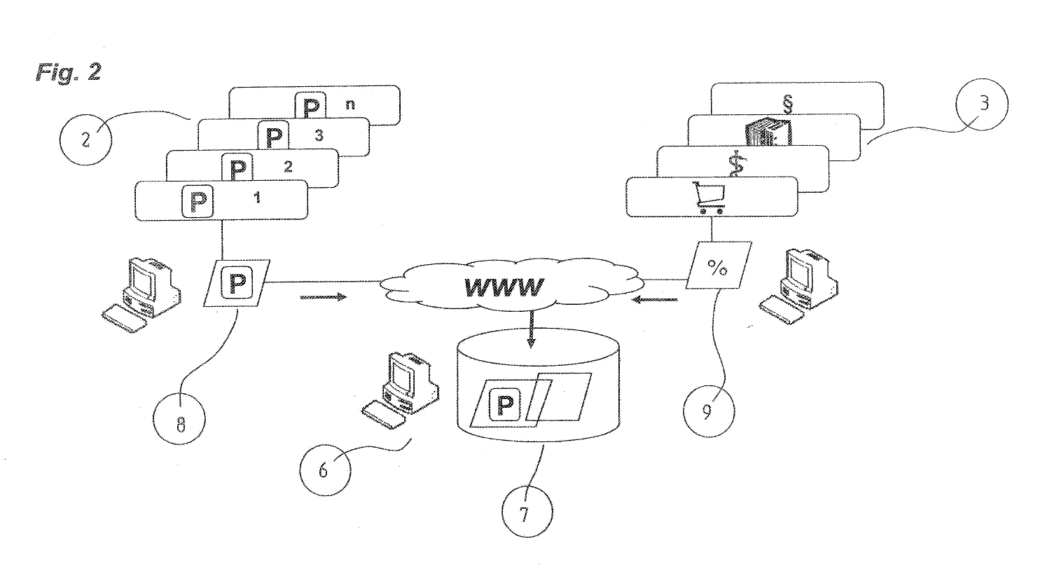

FIG. 2 shows the entering operation of data by car park one 2 and the pre-booking of contingencies as well as the defining of discounts and discount terms 9 by the establishments open to the public 3. Depending on how the data base 7 is set up car park operators 2 can enter locations, different spaces suitable for different vehicles, charges, contingencies etc. The establishments open to the public 3 can enter pre-reservations, pre-bookings, discount terms, time periods etc. 9. In this way the data base 7 is updated.

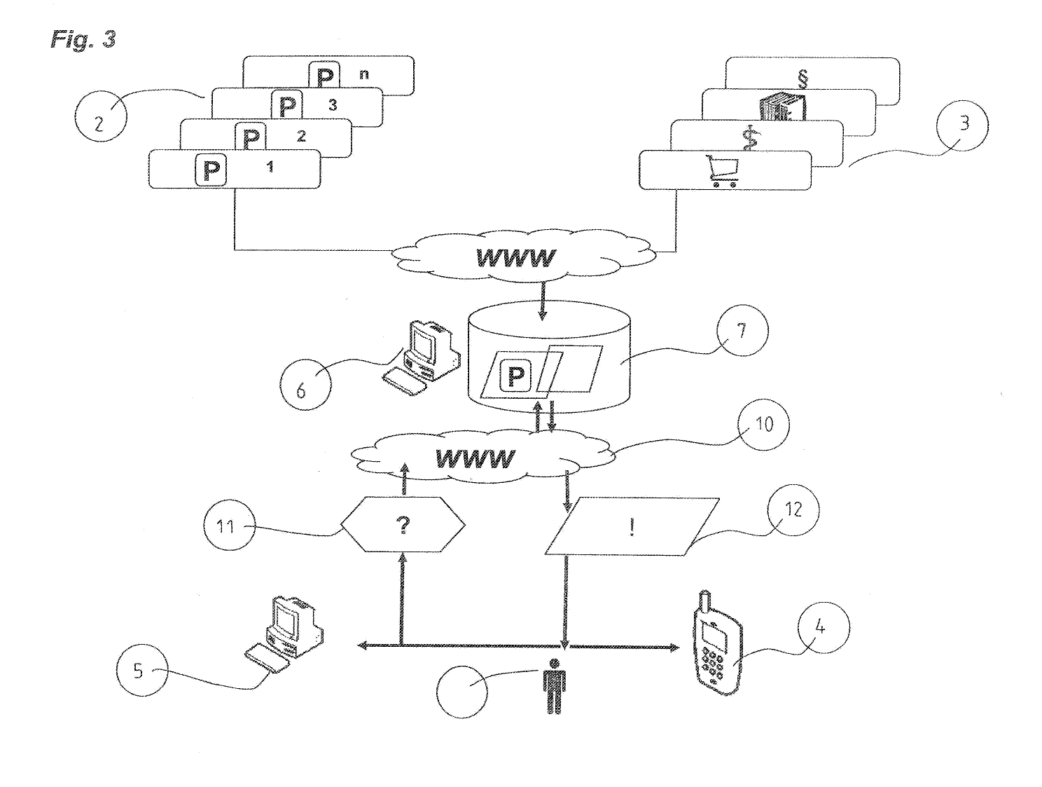

FIG. 3 shows how the system is queried 11 by a customer 1 looking for a parking space subject to certain criteria and shows the response 12 of the system giving a list of available parking spaces as well as their usage terms. Using the described system a customer 1 may start a query 11 via a mobile terminal 4 or a stationary terminal 5. For example, he could query available spaces at a point of time X in the vicinity of shop Y. The response he receives, and from which he can choose, comprises a list of car parks, multi-storey car parks, location in relation to the shop, for example the distance, as well as usage terms such as prices, discounts etc. This is sent via the internet 10 from the central computer 6 to the customer.

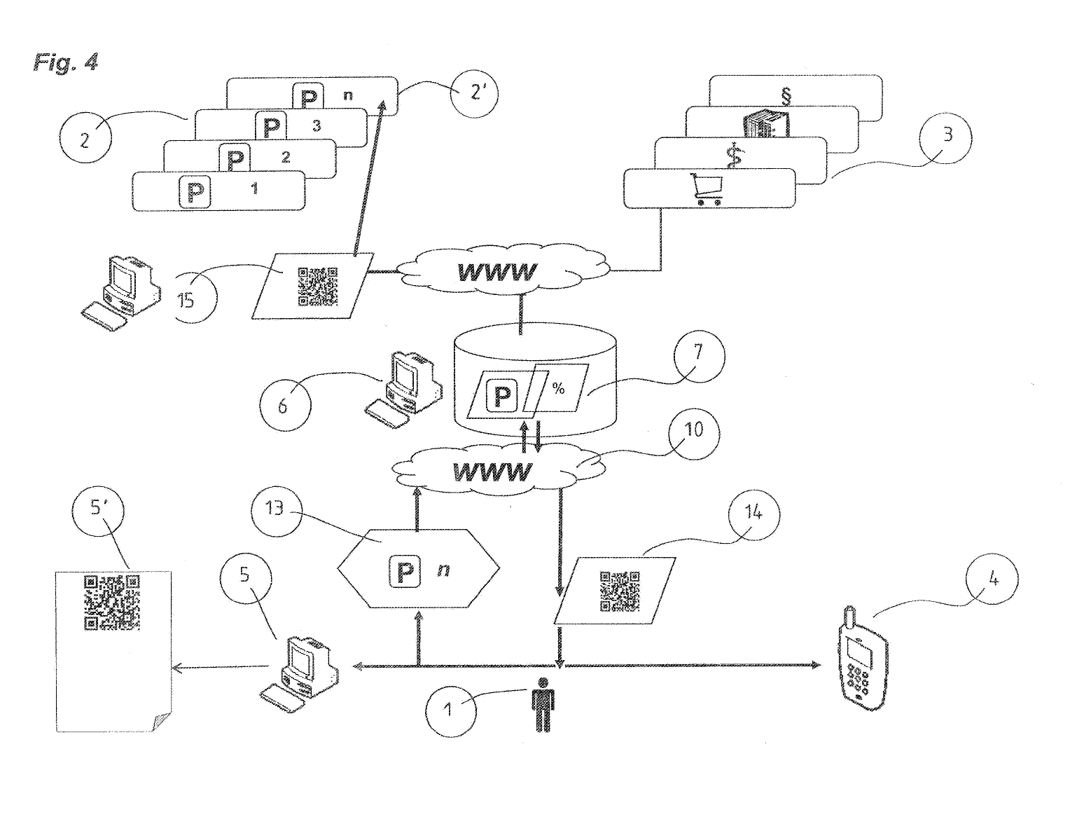

FIG. 4 shows the selection 13 of a parking space by the customer and the system response to the customer 1 at 14 and the selected multi-story car park 2′ at 15. After the customer has selected the desired parking space, he receives from the central computer 6 an authorisation ID code 14. This he can either print out via stationary terminal 5 thus generating an ID code carrier 5′, or he has it on the mobile terminal 4. In addition availability of the parking space is registered in the data base. Optionally a reservation 15 with the code can also be communicated to the car park operator. The latter can then reserve parking space 2′.

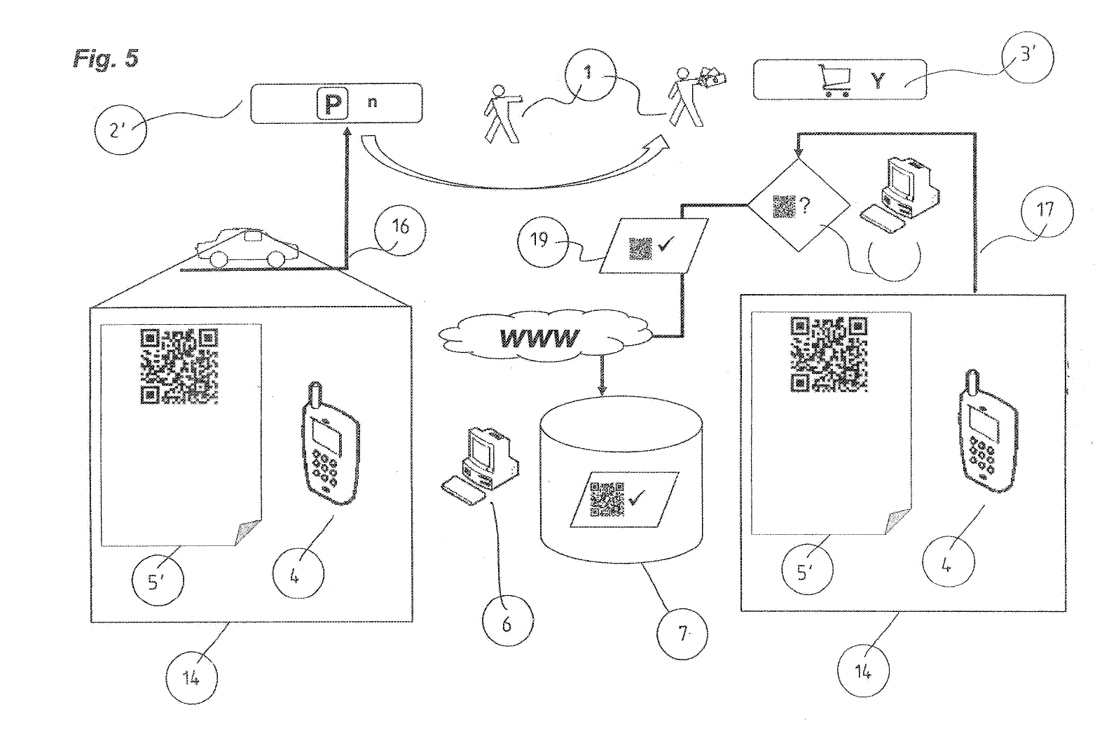

FIG. 5 shows customer 1 entering 16 the multi-story car park 2′ using the previously obtained ID code 14 and—via the same ID code 14—the identification 17 of customer 1 at the visited establishment 3′ and a check 18 on the discount terms for obtaining the discount. The granted discount is stored 19 in the data base 7 of the system.

After the customer 1 has occupied his parking space 2′ he then moves, for example, to shop Y 3′ where the discount terms 18 are checked using code 19. The data base receives corresponding information. The check may take place using printout 5′ or mobile terminal 4 which are presented by the customer as identification 14 for the discount. Discount in terms of the present description is understood to mean all commercial advantages which an establishment open to the public 3 is prepared to offer to a customer 1. This may be sponsorship or the granting of special purchasing conditions.

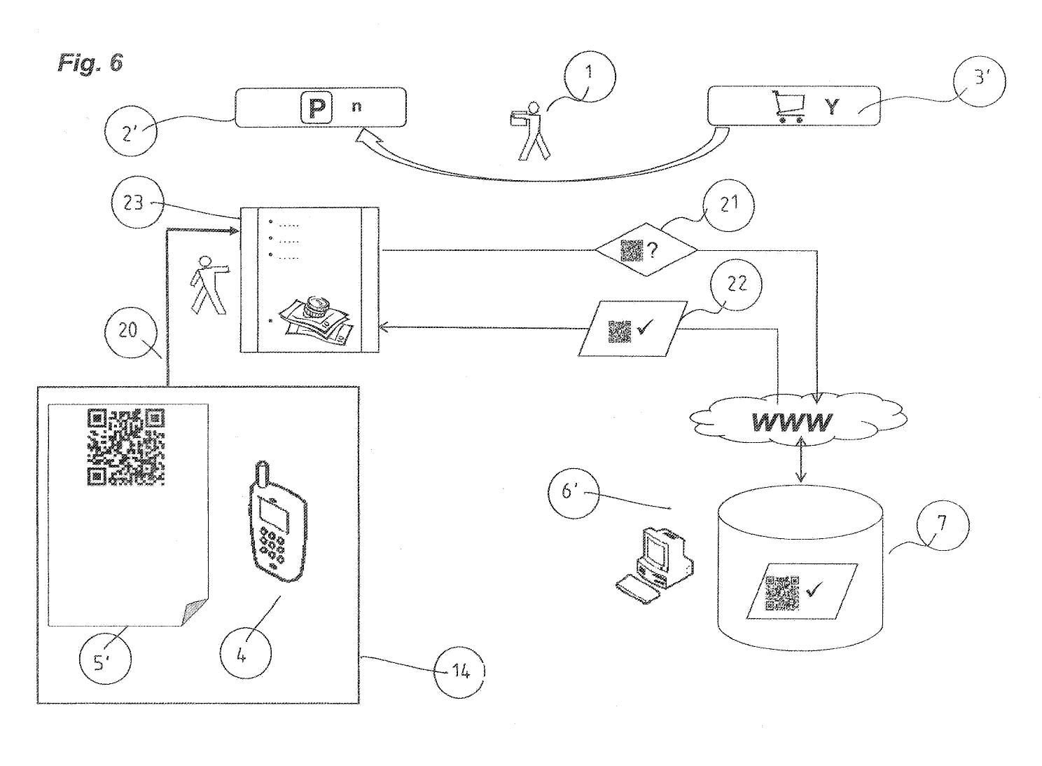

FIG. 6 shows the payment operation in the multi-storey car park 2′ with identification 20 of customer 1 via the ID code 14 and query 21 concerning discounts 22 stored by the ID Code in the data base. Finally the customer 1 returns to his parking space 2′. The car park operator 2 can then arrange for the payment operation to take place automatically. The ID code may be read and the discount 21 be queried by the data base 7 via the ID-Code from the central computer 6. The discount response 22 is then used to calculate 23 the charge and arrange payment.

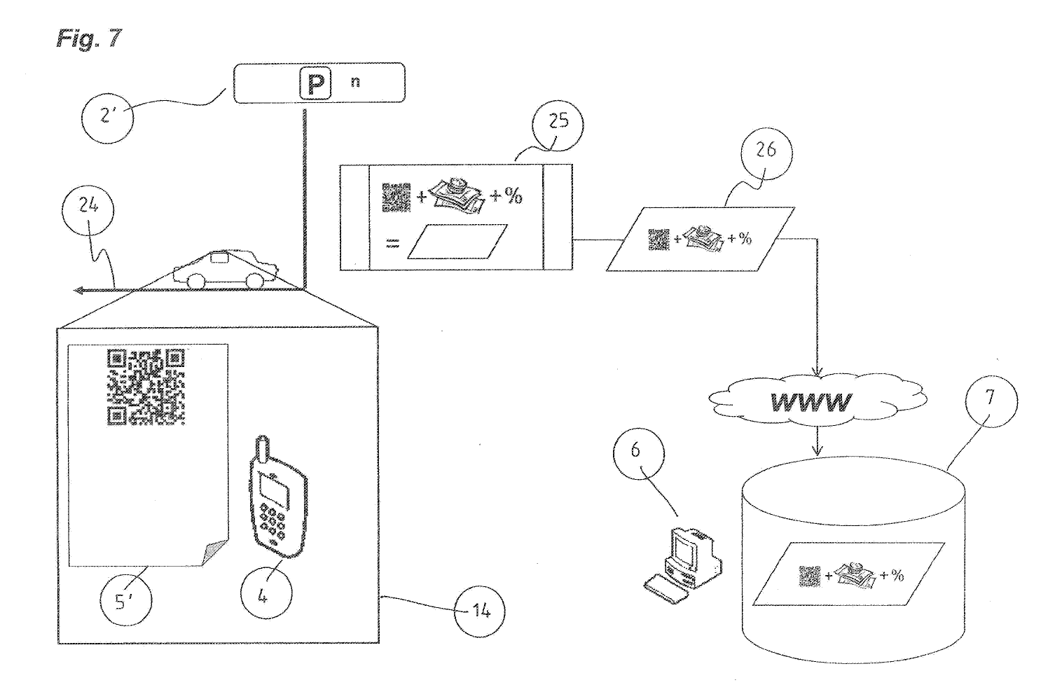

FIG. 7 shows the exit 24 of the customer from the multi-story car park 2′ with the aid of ID code 14. On the side of the system the transaction is concluded in that transaction 25 including the discount used is entered 26 into the data base of the central computer. Upon leaving parking space 2′, in order to conclude the payment operation, for example, at the exit 24 of a multi-storey car park, the customer presents his ID code 14 either using his mobile terminal 4 or the printout 5′. Using the transaction data 25 the transaction 26 is then effected via the data base 7 of central computer 6.

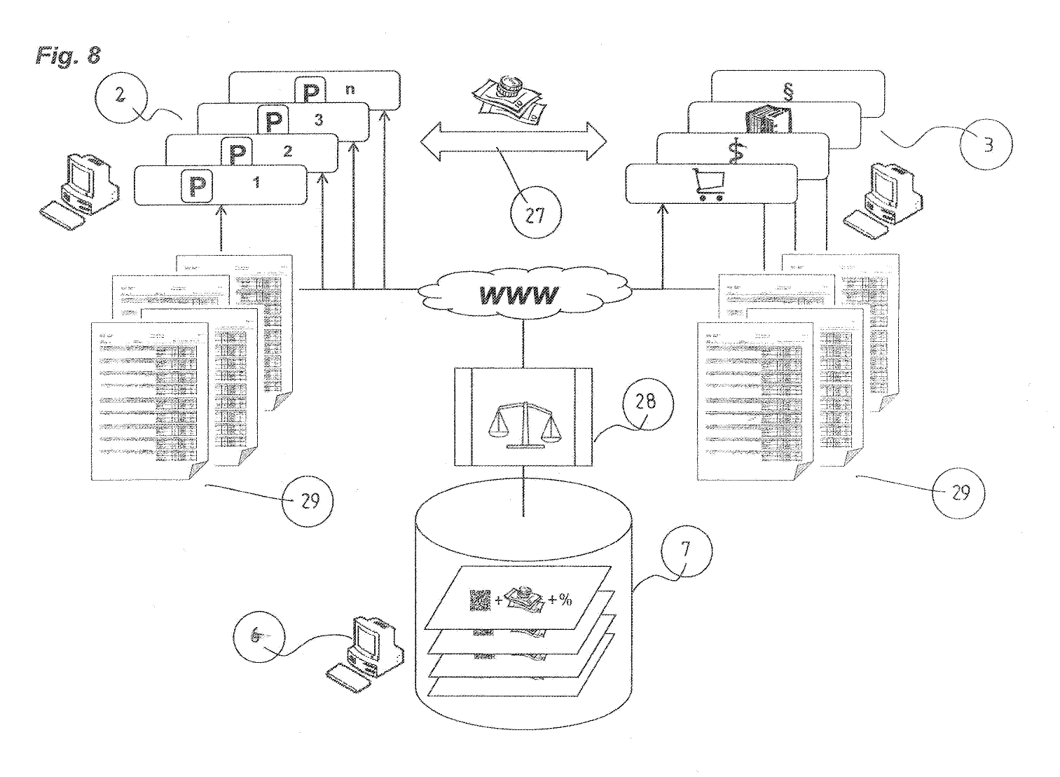

FIG. 8 shows, how at a later point in time the system, via billing module 28 of central computer 6, makes statements 29 on discounts granted available to the car nark operators and establishments 3. Settlement 27 of discounts takes place based on statements 29.

In order to claim his discount customer 1 identifies 17 himself at the discount-granting establishment 3′ by means of ID 14. The establishment 3′ comprises a suitable reader for reading ID 14 and a network connection to the central computer (for example a SSL-encoded internet connection) which is part of the invention, by means of which the establishment 3′ can confirm fulfillment 14 of the discount terms relating to the read ID 14. The data base 7 registers the granting 19 of a discount of a given amount on the current parking operation to this ID 14, and the establishment 3′, with which the car park operator 2′ would automatically settle 27 this discount (fully documented) in statements 29 at a later time.

When finalising the parking operation the customer 1 identifies 20 himself with ID 14 in order to pay for the parking, whereupon he can leave 24 the parking area by having his ID 14 read at the exit barrier. Registered customers (see below) can have their ID 14 read 24 at the exit barrier without having previously paid and can leave the parking area; the parking operation for registered customers is processed in the background with the account of the registered customer being charged accordingly.

Independently of the type of payment the invention checks 21, 22, whether a discount entitlement exists when paying with the aid of ID 14, and then applies the corresponding discount. The complete transaction data including the granted discount is recorded 25 and made available 26 to data base 7. The transaction data contains sufficient details for later settlement 27 of the discount between the establishment 3′ and the car park operator 2′, such as date, time, total price, discount, identification of discount-granting establishment 2′, etc.

Finally the billing system is used to perform the transfer of money by a billing process 28 which results in settlements 27 between car park operators 2 and establishments open to the public 3. The central computer system 6 keeps the transactions in data base 7 based on the billing operations. This results in a credit 8 for the car park operators 2. This can be supplemented by the discounts granted by the establishments open to the public 3 resulting in a balance 27.

The embodiment described is given for clarification and has no limiting effect.

The specification incorporates by reference the entire disclosure of European priority application 12 161 550.4 having a filing date of Mar. 27, 2012.

### LIST OF REFERENCE CHARACTERS

1 customers
2 car park operators
2′ multi-storey car park
3 establishments as open to the public
3′ shop
4 mobile terminal
5 stationary terminal
5′ printout of authorisation identification code (ID code for short)
6 central computer
7 data base
8 data entered by car park operator
9 data entered by establishment
10 Internet/data connection
11 query
12 response
13 selection
14 authorisation ID code
15 reservation sent with associated ID code
16 operation of entering the selected multi-story car park
17 identification of customer
18 checking discount terms
19 discount record for ID code
20 identification of customer
21 querying the system regarding discount
22 response by the data base regarding discount
23 calculate charge
24 exit
25 recording transaction data
26 transaction record sent
27 discount settlement
28 central computer billing module
29 billing records

What is claimed is:

1. A method for automatically communicating parking spaces, comprising the steps of:
a) recording parking spaces of different car park operators at different locations, provided for utilisation, by a central computer in a data base, indicating at least the location, availability, and usage terms and being provided. for automatic management and for being queried via a computer-based network;
b) offering suitable parking spaces to a customer starting a query for selection including usage terms, wherein during the query destination is indicated;
c) electronically communicating an automatically generated authorisation identification code to the customer when booking a parking space.

2. Method according to claim 1, wherein during the query destination and planned usage period are indicated and parking spaces are determined by the central computer and communicated indicating location, availability and usage terms.

3. Method according to claim 1, wherein a physical identification medium is generated in accordance with the authorisation identification code.

4. Method according to claim 1, wherein discount terms of an establishment linked to the car park operator are recorded and managed as part of the usage terms.

5. Method according to claim 1, wherein a booking selection with different parameters such as distance and/or cost is communicated to the customer.

6. Method according to claim 1, wherein a mobile communications network is used as the computer-based network.

7. Method according to claim 1, wherein a mobile terminal looking up and booking parking spaces is used by the customer.
